(19) United States
(12) Patent Application Publication
(10) Pub. No.: US 2008/0136382 A1
(43) Pub. Date: Jun. 12, 2008

(54) REFERENCE VOLTAGE GENERATOR FOR REDUCED VOLTAGE OVERSHOOT IN A SWITCH MODE REGULATOR AT THE END OF SOFT-START

(75) Inventors: Shanmuganand Chellamuthu, Richardson, TX (US); Md Abidur Rahman, Allen, TX (US); Luthuli Edem Dake, McKinney, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/567,481

(22) Filed: Dec. 6, 2006

(51) Int. Cl. G05F 1/00

(52) U.S. Cl. 323/234

(57) ABSTRACT

The reference voltage generator for a switch mode regulator includes: a reference voltage source; a soft-start voltage generator; and a comparator having a directional offset for comparing an output of the reference voltage source with an output of the soft-start voltage generator. Because of the intentional directional offset, the pass switch does not turn ON during the transition from the ramp voltage to reference voltage, therefore reducing energy stored in the inductor. Thus the voltage overshoot is reduced during the end of the soft-start cycle.

### FIELD OF THE INVENTION

The present invention relates to electronic circuitry and, in particular, to circuitry for voltage overshoot reduction of switch mode power supplies at the end of soft-start.

### BACKGROUND OF THE INVENTION

A high voltage, buck type switch mode regulator has a large voltage overshoot when it comes out of soft-start to normal operation after powerup. The overshoot is particulary high when the voltage regulator has higher input power supply and regulating to a lower voltage.

If the supply voltage is higher, and when pass switch turns ON, it builds up more energy in the external inductor, so that even when the pass switch is turned OFF, the ouput voltage overshoots because of the stored energy in the Inductor.

A conventional circuit diagram of a prior art switch mode regulator is shown in FIG. 1. The prior art circuit of FIG. 1 includes soft start ramp generator 20; bandgap voltage source 22; comparator 24; inverter 26; comparator 28; gatedrive level shifter 30; pass transistor 32; diode 34; inductor 36; capacitor 38; feedback resistors 40 and 42; switches 44 and 46; input voltage VIN; and output voltage VOUT.

The prior art circuit of FIG. 1 operates as follows: Since these voltage regulators carry high load currents(in the order of a few Amps), a soft-start circuit 20 is always used to reduce voltage over-shoot. During soft-start, the soft-start circuit 20 generates a ramp voltage. A comparator 24 compares the ramp voltage to a bandgap voltage or a multiplier of band-gap voltage from source 22. The output of the comparator 24 is used to make a decision when to switch over from the soft-start voltage to the bandgap voltage.

The other part of the buck regulator is another comparator 28 which compares the fed reference voltage to the feedback voltage derived from the feed back resistors 40 and 42 (feedback device) which monitors the output regulated voltage VOUT.

When the soft-start ramp voltage is equal to the bandgap voltage, the reference voltage switches from the ramp voltage to the bandgap voltage. This is when the problem arises. Even when the bandgap voltage is a few microvolts higher than the ramp voltage after the transition, the pass transistor 32 is allowed to turn ON, thereby increasing the current in inductor 36. Even when the pass transistor 32 is switched OFF, the stored energy in the inductor 36 makes the output regulated voltage over-shoot. This voltage over-shoot is particularly high when the input supply voltage VIN is high and the regulated output voltage VOUT is small.

### SUMMARY OF THE INVENTION

A reference voltage generator for a switch mode regulator includes: a reference voltage source; a soft-start voltage generator; and a comparator having a directional offset for comparing an output of the reference voltage source with an output of the soft-start voltage generator. Because of the intentional directional offset, the pass switch does not turn ON during the transition from the ramp voltage to reference voltage, therefore reducing energy stored in the inductor. Thus the voltage overshoot is reduced during the end of the soft-start cycle.

### BRIEF DESCRIPTION OF THE DRAWINGS

In the drawings:

FIG. 1 is a circuit diagram of a prior art reference voltage generator in a switch mode regulator circuit;

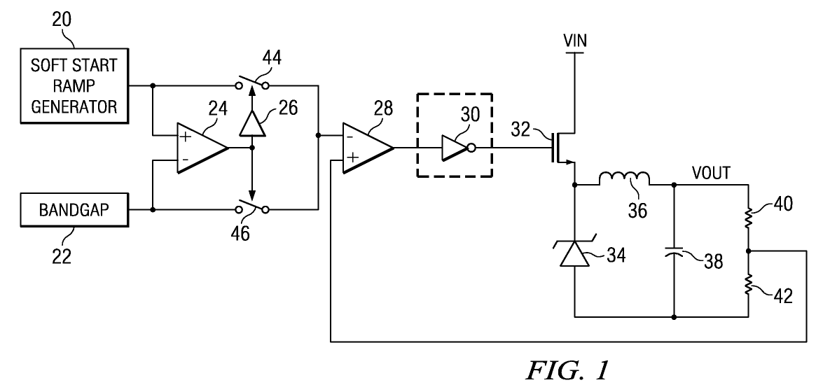

FIG. 2 is a circuit diagram of a preferred embodiment reference voltage generator in a switch mode regulator circuit with reduced voltage overshoot at the end of soft-start.

### DETAILED DESCRIPTION OF PREFERRED EMBODIMENTS

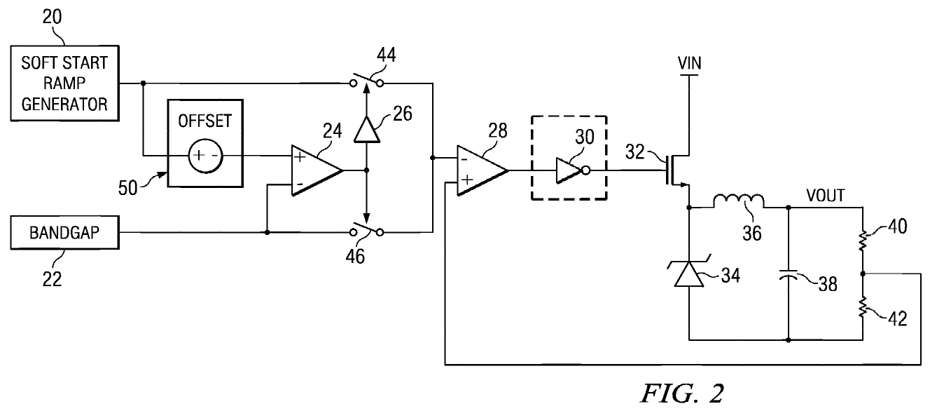

Large voltage overshoots can be avoided if the energy built up in the external inductor is small. In the preferred embodiment circuit of FIG. 2, a comparator with an intentional directional offset 50, is used to make a decision when to switch over from the ramp voltage to the bandgap voltage. The directional offset 50 is set inside the comparator 24, in such a way that there is no current build up on the external inductor 36 at the end of the soft start cycle, thereby avoiding current build up in the inductor 36 after soft-start.

In the prior art, the reference voltage is switched from the soft-start ramp voltage to the bandgap voltage, when the soft-start ramp voltage is equal to bandgap voltage. In preferred embodiment circuit of FIG. 2, the reference voltage is switched from the soft-start ramp voltage to the bandgap voltage, when the soft-start ramp voltage is equal to the bandgap voltage plus a few millivolts(intentional directional offset voltage).

Because of the intentional directional offset, the pass switch 32 does not turn ON during the transition from the ramp voltage to bandgap voltage, therefore there is no energy stored in the inductor 36. Thus the voltage overshoot is reduced during the end of the soft-start cycle.

The preferred embodiment provides the advantages of reduced voltage overshoot during power-up of a switch mode regulator at the end of soft-start and requires very little silicon area.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. A reference voltage generator for a switch mode regulator comprising:
a reference voltage source;
a soft-start voltage generator; and
a comparator having a directional offset for comparing an output of the reference voltage source with an output of the soft-start voltage generator.

2. The device of claim 1 wherein the soft-start voltage generator is a ramp voltage generator.

3. The device of claim 1 wherein the reference voltage source is a bandgap voltage source.

4. The device of claim 1 wherein the comparator switches when the output of the soft-start voltage generator is greater than the output of the reference voltage source.

5. The device of claim 1 wherein the comparator switches when the output of the soft-start voltage generator is greater than the output of the reference voltage source by an amount equal to the directional offset.

6. The device of claim 1 wherein an output of the reference voltage generator is the output of the soft-start voltage generator when the output of the reference voltage source is greater than or equal to the output of the soft-start voltage generator.

7. The device of claim 1 wherein an output of the reference voltage generator is the output of the soft-start voltage generator when the output of the reference voltage source plus the directional offset is greater than the output of the soft-start voltage generator.

8. The device of claim 1 wherein an output of the reference voltage generator is the output of the reference voltage source when the output of the reference voltage source is less than the output of the soft-start voltage generator.

9. The device of claim 1 wherein an output of the reference voltage generator is the output of the reference voltage source when the output of the reference voltage source plus the directional offset is less than the output of the soft-start voltage generator.

10. The device of claim 1 further comprising:
a first switch coupled between the soft-start voltage generator and an output of the reference voltage generator; and
a second switch coupled between the reference voltage source and the output of the reference voltage generator.

11. The device of claim 10 wherein the first and second switches are controlled by an output of the comparator.

12. The device of claim 11 wherein the first switch is ON and the second switch is OFF when the output of the reference voltage source is greater than or equal to the output of the soft-start voltage generator.

13. The device of claim 11 wherein the first switch is OFF and the second switch is ON when the output of the reference voltage source is less than the output of the soft-start voltage generator.

14. The device of claim 11 wherein the first switch is ON and the second switch is OFF when the output of the reference voltage source plus the directional offset is greater than the output of the soft-start voltage generator.

15. The device of claim 11 wherein the first switch is OFF and the second switch is ON when the output of the reference voltage source plus the directional offset is less than the output of the soft-start voltage generator.
